(19) United States
(12) Patent Application Publication
(10) Pub. No.: US 2006/0050155 A1
(43) Pub. Date: Mar. 9, 2006

(54) Video camera sharing

(76) Inventors: Stephen S. Ing, Beaverton, OR (US); Manoj Agnihotri, Lake Oswego, OR (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/932,566

(22) Filed: Sep. 2, 2004

(51) Int. Cl. H04N 5/76

(52) U.S. Cl. 348/231.99

(57) ABSTRACT

Systems, methods, and software share an output of a video capture device, such as a video camera, amongst more than one application. Some embodiments comprise writing video frames to a shared memory buffer that is accessible by one or more applications. Some applications are virtual device drivers that appear as actual device drivers of the video capture device producing the video data. Some embodiments comprise acquiring exclusive control of a video capture device driver, allocating a shared memory buffer, receiving a video frame from the video capture device driver, and writing the video frame to the shared memory buffer. In some embodiments, the shared memory buffer comprises two shared memory buffers that are written to and read from in an alternating fashion.

### BACKGROUND INFORMATION

Video cameras for computer systems are becoming more common in today's computing environment. Further, more and more applications are capable of utilizing captured video from video cameras. However, access to video cameras by computer system applications is generally limited to a single application. Device drivers for such video cameras are mutually exclusive, prohibiting shared use of the video cameras amongst multiple applications. Once an application acquires the video capture device driver, no other application can receive output from the video camera until the controlling application relinquishes control of the driver.

### BRIEF DESCRIPTION OF THE DRAWINGS

FIG. 1 is a schematic of a system according to an example embodiment of the inventive subject matter.

FIG. 2 is a flow diagram of an example embodiment of the inventive subject matter.

FIG. 3 is a block diagram of an example embodiment of a method of the inventive subject matter.

FIG. 4 is a block diagram of an example embodiment of a method of the inventive subject matter.

FIG. 5 is a block diagram of an example embodiment of a method of the inventive subject matter.

FIG. 6 is a flow diagram of an example embodiment of the inventive subject matter.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein may be implemented in hardware, software or a combination of software and hardware. The software comprises computer-executable instructions stored on a computer readable medium such as memory or other type of storage device. The term “computer readable medium” is also used to represent carrier waves on which the software may be transmitted. Further, such functions correspond to modules, which are software, hardware, firmware, or any combination thereof. Multiple functions are performed in one or more modules as desired, and the embodiments described are merely examples. The software may be executed on a digital signal processor, an Application Specific Integrated Circuit (ASIC), microprocessor, or other type of processor operating in a system, such as a personal computer, server, router, or other device capable of processing data, including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations or combinations thereof.

As used herein, the terms “video” is used to encompass captured images, still and moving. Thus, the term “video” is intended as a broad term and is not intended to limit the breadth of this disclosure or the claims.

As used herein, the term “mutually exclusive” is used in describing device drivers that prohibiting shared use of the video cameras amongst multiple applications. Such “mutually exclusive” device drivers are acquired by a first application and cannot be acquired by another application until the first application releases the driver.

The inventive subject matter provides various systems, methods, and software to share a video capture device, such as a video camera, amongst multiple applications on a computing system. Some such embodiments include a server process that acquires exclusive control over a mutually exclusive video capture device driver and writes captured video to a memory buffer that is accessible to other applications on a system. One or more other processes on the system then read the video from the memory buffer and provide the video to one or more applications. Various embodiments are illustrated in the figures and described below.

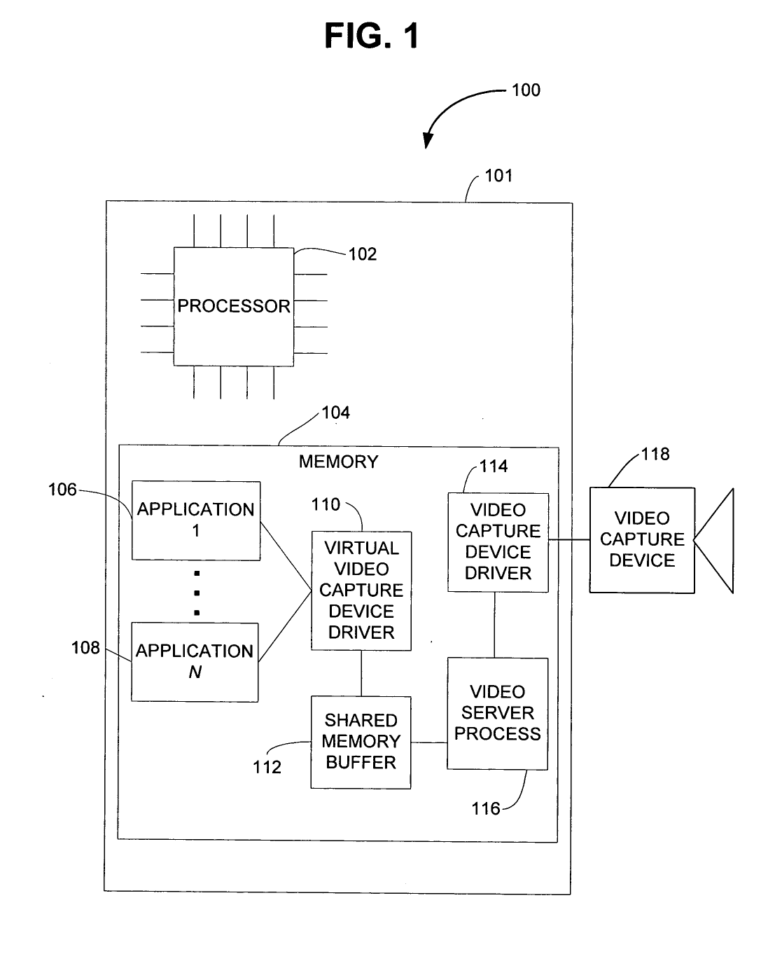

FIG. 1 is a schematic of a system 100 according to an example embodiment of the inventive subject matter. The example embodiment of system 100 provides one of many possible hardware and/or software arrangements of the inventive subject matter. The system 100 includes a computing device 101 having a processor 102, a memory 104, and a video capture device 118. The memory 104 includes a plurality of applications 1-N of which applications 1 and N are identified by 106 and 108, respectively. The memory 104 further includes a virtual video capture device driver 110, a shared memory buffer 112, a video server process 116, and a video capture device driver 114.

The computing device 101 represents any type of computing device capable of operating with a video capture device 1118. Some examples of such a computing device 101 include a computer, a personal computer, a server, a personal digital assistant (PDA), or virtually any other type of computing device 101. The computing device 101 can also be of any architecture utilizing virtually any operating system.

The processor 102 of the computing device 101 represents a digital signal processor or processing unit of any type of architecture, such as an ASIC (Application-Specific Integrated Circuit), a CISC (Complex Instruction Set Computer), RISC (Reduced Instruction Set Computer), VLIW (Very Long Instruction Word), or hybrid architecture, although any appropriate processor may be used. The processor 102 executes instructions. The processor 102 also includes a control unit that organizes data and program storage in memory, such as memory 104, and transfers data and other information in and out of the computing device 101, such as to and from the video capture device 118, and, in some embodiments, to and from one or more network connections (not shown) over an optional network interface (not shown). Although only a single processor is illustrated within computing device 101, the computing device 101, in some embodiments, includes multiple processors 102.

The memory 104 represents one or more mechanisms to store data. For example, the memory 104, in various embodiments, includes one or more of a random access memory (RAM), magnetic disk storage media, optical storage media, flash memory devices, and/or other volatile and non-volatile machine-readable media. In other embodiments, the memory includes any appropriate type of storage device or memory 104. Although only one memory 104 is shown, multiple memories 104 of various types and multiple types of storage devices can be present.

The video capture device 118, in some embodiments, is a device capable of capturing video, such as a video camera. In various embodiments, the video capture device 118 can capture single frames of video, multiple frames over time, or both. The video capture device 118 can be coupled to the computing device 101 in various ways. For example, the video capture device 118 can be operatively coupled to the computing device 101 via a cable, such as a Universal Serial Bus (USB) cable. Other embodiments include the video capture device operatively coupled to the computing device 101 via a wireless connection such as a Bluetoothe wireless connection, or other wired or wireless connection device or technology capable of delivering captured video from the video capture device 118 to the computing device 101.

In some embodiments, the video capture device 118 can capture color video at a rate of 30 frames per second at a resolution of 640×480 pixels. This video capture device 118 can capture still images at a resolution of 1.3 megapixels. In other embodiments, the video capture device 118 is capable of capturing video and still images at greater and lesser resolutions and at greater and lesser frame rates per second. In some embodiments, the properties of captured video can be altered by adjusting one or more parameters of the video capture device 118. Some such settings include the resolution at which video is captured. Other settings include frame rate, sharpness, brightness, focus, zoom, color, camera angle or position, and virtually any other setting to adjust one or more properties or subjects of captured video.

Some further embodiments of the video capture device 118 include a microphone. In some such embodiments, the video capture device 118 can deliver a multiplexed signal to the computing device 101, the multiplexed signal comprising video and audio.

The video capture device 118 is operatively coupled to the computing device 101, as described above. The video capture device driver 114 receives video from the video capture device 118. In some embodiments, the video capture device driver 114 also provides commands to the video capture device 118. Such commands include commands to alter the properties of the video captured by the video capture device 118. The video capture device driver 114, in some embodiments, is a mutually exclusive device driver, allowing only a single application operating on the computing device 101 to use the video capture device driver 114. In some embodiments, the video capture device driver 114 is a driver supplied by the vendor/manufacturer of the video capture device 118.

The video server process 116 is a process that acquires control over the video capture device driver 114. The video server process 116 further allocates a shared memory buffer 112 in the memory 104 if the shared memory buffer 112 has not yet been allocated. The video server process 116, once the video capture device driver 114 has been acquired and the shared memory buffer 112 has been allocated, writes video received from the video capture device driver 114 to the shared memory buffer 112. The writing of video to the shared memory buffer 112 may be performed frame-by-frame, each frame overwriting a previous frame. In some embodiments, there are two or more shared memory buffers 112. In such multi-shared memory buffer 112 embodiments, the video is written in an alternating fashion between the shared memory buffers.

The shared memory buffer 112 is an area of memory allocated to be available to the video server process 116 and other applications. The shared memory buffer 112 is of a size at least large enough to hold a video frame. In embodiments including more than one shared memory buffer 112, each shared memory buffer 112 is of a size at least large enough to hold a video frame. Video frames written to the shared memory buffer 112 by the video server process 116 can be read by other applications, such as a virtual video capture device driver 110. In some embodiments, applications, such as application 106 and application 108, can obtain video directly from the shared memory buffer 112.

The virtual video capture device driver 110, in some embodiments, appears on the computing device 101 as an actual video capture device driver that can be acquired by applications operable on the computing device 101. The virtual video capture device driver 110 reads video from the shared memory buffer 112 and provides the video to one or more applications. Some embodiments of the system 100 include more than one virtual video capture device driver 110. In some embodiments, the virtual video capture device driver 110 is mutually exclusive, allowing only a single application to acquire the virtual video capture device driver 110. In some such embodiments, there are multiple mutually exclusive virtual video capture device drivers to allow more than one application to simultaneously receive video. In other embodiments, as illustrated in FIG. 1, the virtual video capture device driver 110 is a multi-instance virtual driver allowing more than one application to simultaneously acquire the multi-instance virtual driver and receive video.

In some embodiments, the virtual video capture device driver 110 performs transformations on video according to one or more settings. In some embodiments, the video server process 116 receives video from the video capture device driver 114 captured by the video capture device 118 at a high quality, or even of the highest quality the video capture device 118 is capable of. The video server process 116 then proceeds to write this high quality video to the shared memory buffer 112. In some embodiments, the video server process performs one or more transforms on the video, altering one or more video properties, prior to writing the video to the shared memory. The virtual video capture device driver 110 then reads the video from the shared memory buffer 112 and performs any necessary transformations to the video according to one or more settings prior to providing the video to a requesting application. In some embodiments, the settings include settings for one or more of resolution, frame size, frame rate, sharpness, brightness, or virtually any other setting relating to the properties of the video. In various embodiments, these settings are provided by an application or by user manipulation of the settings.

Application 106 and application 108 are intended to reflect video-enabled applications. There can be any number of such video-enabled applications operating on the computing device. Examples of such video-enabled applications include video recording applications, video conferencing applications, instant messenger applications, video surveillance applications, and virtually any other type of application capable of receiving or requesting video originating with a video capture device 118.

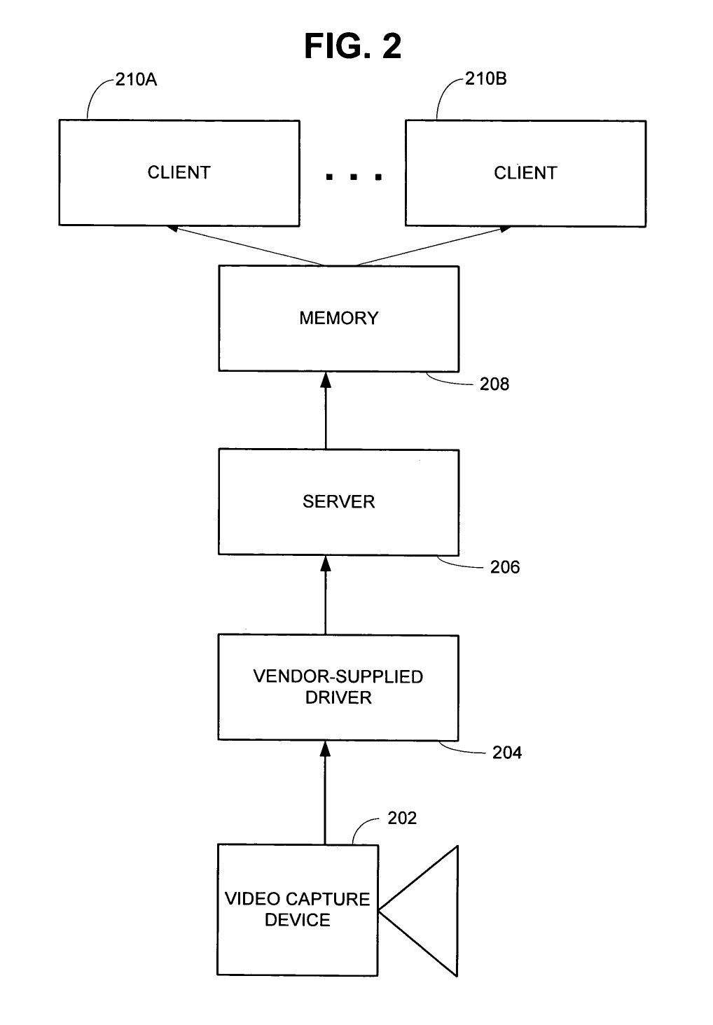

FIG. 2 is a flow diagram of an example embodiment of the inventive subject matter. FIG. 2 provides a high-level view of captured video flowing from a video capture device 202 to one or more client applications 210 that provide the captured video to one or more user applications (not shown). The video capture device 202 may be identical to or different from the video capture device 118 of FIG. 1.

The example illustration of FIG. 2 includes a video capture device 202 providing video to a vendor-supplied driver 204. The vendor-supplied driver 204 is a mutually exclusive driver that has been acquired by a server 206. The server 206 operates to receive the video from the vendor-supplied driver 204 and places that video into a memory 208. The memory 208 is a memory that is accessible to applications. Some such applications include clients such as clients 210A and 210B. The function of the clients 210A and 210B is to read video from the memory 208 and provide the video to one or more user applications. The user applications are, generally, any application compatible with the captured video of the video capture device 202.

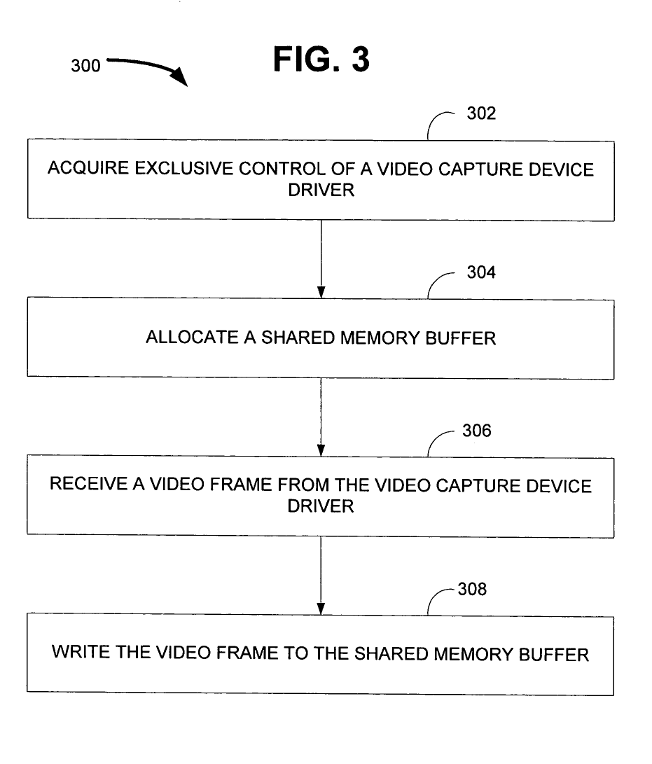

FIG. 3 is a block diagram of an example embodiment of a method 300 of the inventive subject matter. The method 300 includes acquiring exclusive control of a video capture device driver 302 and allocating a shared memory buffer 304. The method 300 further includes receiving a video frame from the video capture device driver 306 and writing the video frame to the shared memory buffer 308. In some embodiments, the method 300 further includes receiving another video frame from the video capture device 306 and again writing the video frame to the shared memory buffer 308. The method 300 then iterates through these portions (i.e., 306 and 308) of the method while video frames are being received.

The shared memory buffer of the method 300 is accessible by one or more applications, such as a virtual video capture device driver. The virtual video capture device driver provides video to video-enabled applications, appearing to the applications as an actual device driver.

In some embodiments, allocating a shared memory buffer includes allocating a space in a system memory, such as a random access memory (RAM). The amount of memory allocated varies depending on the properties of the video captured. Generally, higher resolution video will require allocating a larger shared memory buffer. In addition, the format used in capturing and transmitting the video may affect the memory size required. Further, if the video is multiplexed to include associated audio, the memory space required may be affected.

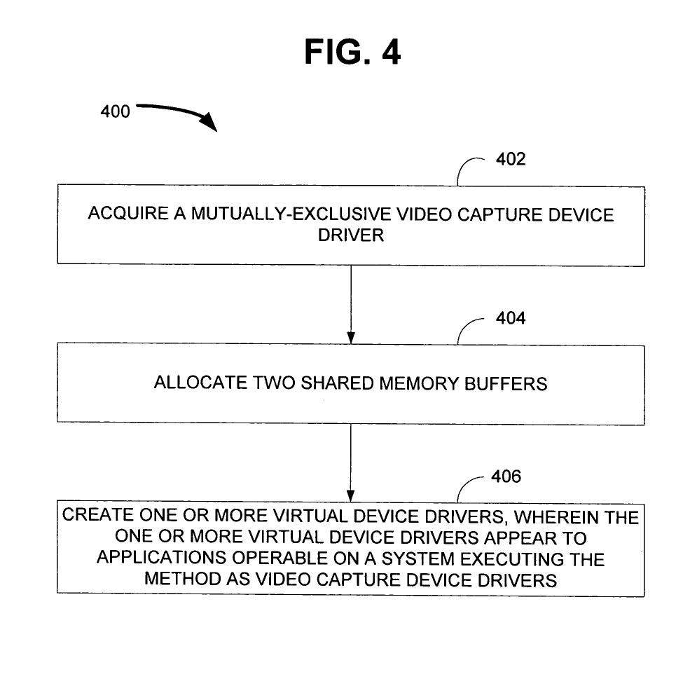

FIG. 4 is a block diagram of an example embodiment of a method 400 of the inventive subject matter. The method 400 includes acquiring a mutually-exclusive video capture device driver 402, allocating two shared memory buffers 404, and creating one or more virtual device drivers, wherein the one or more virtual device drivers appear to applications operable on a system executing the method as video capture device drivers 406. Some embodiments of the method 400 further include receiving a stream of video frames from the video capture device driver and writing the video frames in an alternating manner between the two shared memory buffers. The virtual device drivers created by the method 400 are operable to provide video to the applications operable on the system by reading the video frames in an alternating manner from the two shared memory buffers.

In some embodiments of the method 400, creating one or more virtual device drivers 406 comprises creating a fixed number of mutually exclusive virtual device drivers. In some embodiments, the fixed number is two, while in other embodiments the fixed number is ten. However, any number of mutually exclusive device drivers can be created by the method 400. In some embodiments, the number of mutually exclusive device drivers is the maximum number of video-enabled applications that can receive video from the method 400 at one time. In some other embodiments, if all of the mutually exclusive device drivers are utilized, a system implementing the method 400 dynamically creates one or more additional mutually exclusive device drivers.

In some embodiments, a mutually exclusive device driver is a copy of a vendor-supplied device driver, altered in a fashion to cause the mutually exclusive device driver to read video data from a shared memory buffer rather than from a video capture device. In other embodiments, the mutually exclusive device driver comprises software written to appear as a device driver for a video capture device couplable to a system implementing the method 400.

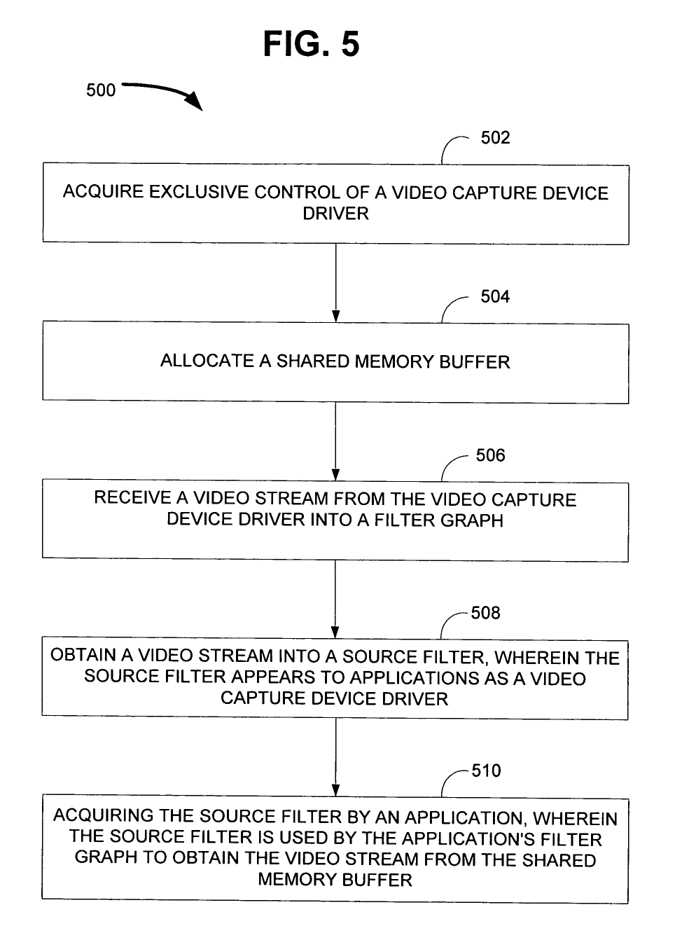

FIG. 5 is a block diagram of an example embodiment of a method 500 of the inventive subject matter. The method 500 is an example embodiment of the method 500 on a system having a Microsoft® Windows® operating system including DirectShow®.

Microsoft's DirectShow® architecture is based upon filters. Generally, a filter performs one operation on a data stream, such as a stream of video frames. Some filter operations include reading files or streams, passing data to a video card or other peripheral device, and transforming data to a particular frame size or to a particular format, such as MPEG-1 (Moving Pictures Experts Group; International Standards Organization/International Electrotechnical Commission Standard 11172) or RGB (Red-Green-Blue).

Generally, there are three filter classes: source filters that obtain video data, transform filters that transform video data in some manner, and render filters that output the video data. Multiple filters can be linked together in a fashion so the output of one filter is the input for the next. Groups of linked filters are called a filter graph. Generally, a filter graph includes at least a source filter and a render filter.

The method 500 includes acquiring exclusive control of a video capture device driver 502 and allocating a shared memory buffer 504. The method further includes receiving a video stream from the video capture device driver into a filter graph 506, obtaining a video stream into a source filter, wherein the source filter appears as a video capture device driver 508, and acquiring the source filter by an application, wherein the source filter is used by the application's filter graph to obtain the video stream from the shared memory buffer 510.

Receiving the video stream from the video capture device driver into a filter graph 506 includes a source filter that obtains the video stream and provides the video stream to a render filter. The render filter then renders the video stream, frame-by-frame, to a shared memory buffer.

Obtaining a video stream into a source filter, wherein the source filter appears to applications as a video capture device driver 508 includes a source filter that can be acquired as a device driver for obtaining the video stream. The source filter, once acquired by an application is then used as the source filter for the application's filter graph to obtain the video stream from the shared memory buffer.

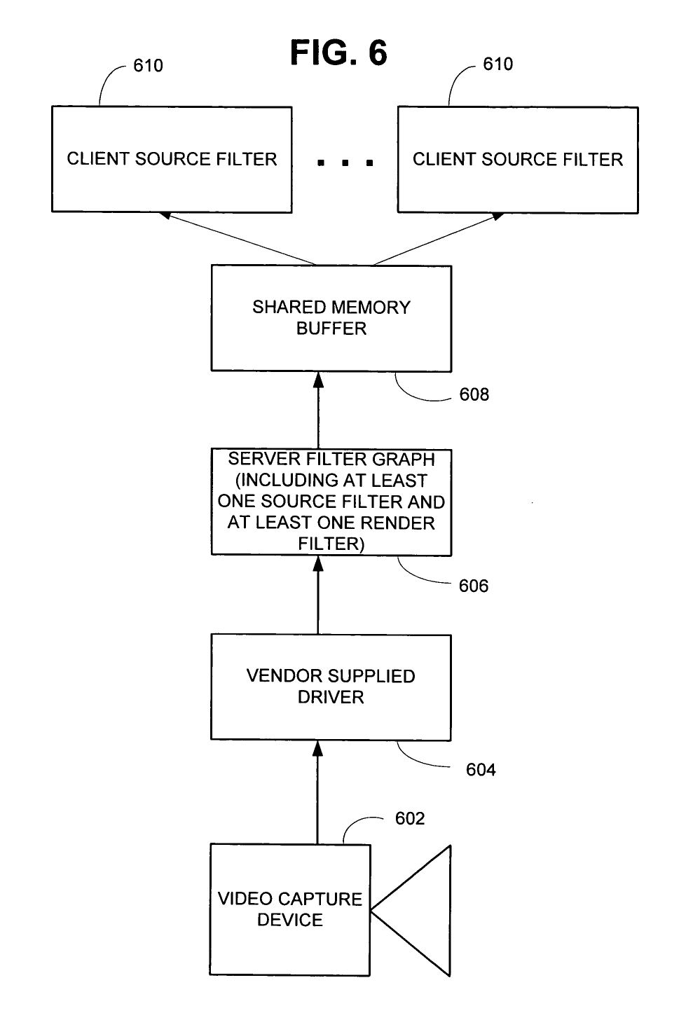

FIG. 6 is a flow diagram of an example embodiment of the inventive subject matter. FIG. 6 provides a high-level view, similar to that of FIG. 2, but it expands on the example embodiment of method 500 provided in FIG. 5. This high-level view includes captured video flowing from a video capture device 602 to one or more client source filters, such as 610A and 610B, that provide the captured video to one or more user applications (not shown). The video capture device 602 may be identical to or different from the video capture device of FIG. 1.

The example illustration of FIG. 6 includes a video capture device 602 providing video to a vendor-supplied driver 604. The vendor-supplied driver 604 is a mutually exclusive driver that has been acquired by a server filter graph 606. The server filter graph 606 includes a source filter that operates to obtain the video from the vendor-supplied driver 604. The server filter graph 606 further includes a render filter that writes the video into a shared memory buffer 608. The shared memory buffer 608 is a memory that is at least accessible to client source filters 610A and 610B. The function of the client source filters 610A and 610B is to operate as source filters filter graphs of for one or more user applications (not shown) by reading video from the shared memory buffer 608 and providing the video to the filter graphs of the one or more user applications.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages that have been described and illustrated in order to explain the nature of this inventive subject matter may be made without departing from the principles and scope of the inventive subject matter as expressed in the subjoined claims.

What is claimed is:

1. A method comprising:
acquiring exclusive control of a video capture device driver;
allocating a shared memory buffer;
receiving a video frame from the video capture device driver; and
writing the video frame to the shared memory buffer.

2. The method of claim 1, wherein the shared memory buffer is accessible by one or more applications.

3. The method of claim 2, wherein the one or more applications are video-enabled applications.

4. The method of claim 1, wherein subsequently received video frames are written to the shared memory buffer, overwriting previous video frames in the shared memory buffer.

5. A method comprising:
writing a video frame to a shared memory buffer, wherein the shared memory buffer is accessible by one or more applications.

6. The method of claim 5, wherein the one or more applications comprise video-enabled applications.

7. The method of claim 6, further comprising receiving a video frame, wherein the shared memory buffer comprises two shared memory buffers and wherein receiving the video frame comprises receiving a stream of video frames, the method further comprising:
alternating writing the stream of video frames between the two memory buffers.

8. The method of claim 5, wherein the shared memory buffer is of a size at least equal to a size necessary to hold a received video frame.

9. The method of claim 5, further comprising:
reading the video frame from the shared memory buffer by the one or more applications.

10. A system comprising:
a memory;
a video capture device;
a video capture device driver to receive captured video frames from the video capture device, wherein the video capture device driver is mutually exclusive; and
software operable on the system to:
allocate a shared memory buffer in the memory;
receive video frames from the video capture device driver; and
write the received video frames to the shared memory buffer.

11. The system of claim 10, wherein the received video frames written to the shared memory buffer are accessible to one or more applications operating on the system.

12. The system of claim 11, wherein the software is a multi-instance virtual driver.

13. The system of claim 12, wherein the multi-instance virtual driver appears to the one or more applications operating on the system as a video capture device driver.

14. The system of claim 10 wherein the software, when executing, has exclusive control of the video capture device driver.

15. An article comprising a machine-accessible medium having associated instructions, wherein the instructions, when accessed, result in a machine performing:
providing video data from a video capture device to two or more applications operable on the machine through a shared memory buffer.

16. The article of claim 15 wherein the instructions, when accessed, further result in a machine performing:
providing one or more virtual video capture device drivers to provide the video data to the two or more applications, the virtual video capture device drivers obtaining the video data from the shared memory buffer.

17. The article of claim 15 wherein the machine comprises a video capture device driver operatively coupled to the video capture device, and wherein the instructions, when accessed, result in the machine performing:
receiving the video data from the video capture device into the video capture device driver; and
writing the video data from the video capture device driver into the shared memory buffer.

18. A method comprising:
acquiring a mutually exclusive video capture device driver;
allocating two shared memory buffers; and
creating one or more virtual device drivers, wherein the one or more virtual device drivers appear to applications operable on a system executing the method as video capture device drivers.

19. The method of claim 18 further comprising:
receiving a stream of video frames from the video capture device driver; and
writing the video frames in an alternating manner between the two shared memory buffers.

20. The method of claim 19, wherein the virtual device drivers are operable to provide video to the applications operable on the system by reading the video frames in an alternating manner from the two shared memory buffers.

21. The method of claim 19, wherein creating one or more virtual device drivers comprises creating a fixed number of mutually exclusive virtual device drivers.

22. A method comprising:
acquiring exclusive control of a video capture device driver;
allocating a shared memory buffer;
receiving a video stream from the video capture device driver into a filter graph, the filter graph including:
a source filter that receives a video stream from the video capture device driver, and
a render filter that writes the video stream, one frame at a time, to a shared memory buffer.

23. The method of claim 22, wherein allocating the shared memory buffer comprises allocating more than one shared memory buffers that are written to by the render filter of the filter graph, one frame at a time, alternating between the memory buffers.

24. The method of claim 22, further comprising:
obtaining a video stream into a source filter, wherein the source filter appears to applications as a video capture device driver; and
acquiring the source filter by ah application, wherein the source filter is used by the application's filter graph to obtain video from the shared memory buffer.

25. The method of claim 22, wherein the video stream is a multiplexed stream including an audio stream.

26. A method comprising:
providing a system with one or more virtual video capture device drivers, wherein the virtual video capture device drivers obtain video data from a shared memory buffer; and
populating the shared memory buffer with video data received from a mutually exclusive video capture device driver.

27. The method of claim 26, wherein the one or more virtual video capture device drivers are mutually exclusive.

28. The method of claim 26, wherein the virtual video capture device drivers include at least a source filter of a filter graph.
